(19) United States
(12) Patent Application Publication
(10) Pub. No.: US 2013/0303241 A1
(43) Pub. Date: Nov. 14, 2013

(54) METHOD AND DEVICE WITH A CUSTOMIZABLE KEY PAD ASSEMBLY

(71) Applicants: Oyeneye O. Coker, Miami, FL (US); Mark A. Barabolak, Elmhurst, IL (US); William H. Robertson, JR., Fort Lauderdale, FL (US)

(72) Inventors: Oyeneye O. Coker, Miami, FL (US); Mark A. Barabolak, Elmhurst, IL (US); William H. Robertson, JR., Fort Lauderdale, FL (US)

(73) Assignee: MOTOROLA MOBILITY, INC., Libertyville, IL (US)

(21) Appl. No.: 13/469,245

(22) Filed: May 11, 2012

(51) Int. Cl. H04W 88/02

(52) U.S. Cl. 455/566; 455/575.1

(57) ABSTRACT

A wireless communication device (200) and method (300) with a customizable key pad assembly. The method (300) can provide the steps of: providing (310) a wireless communication device; connecting (320) a side pad module to the wireless communication device; and coupling (330) an end cap module to the wireless communication device. Advantageously, the method (300) provides an automated, modular and simplified method to assemble a wireless communication device.

### BACKGROUND

1. Field

The present disclosure relates to a method and device with a customizable key pad assembly.

2. Introduction

There is a trend for large displays for wireless communication devices, such as smart phones and tablets, with most if not all of the control being done via touch screen.

This trend has limited the surfaces available on a wireless communication device for styling and customization for the service provider, manufacturer and ultimate end user.

There is a need to provide multiple custom appearances and designs to be created from a single core module.

There is also a need to provide modular assembly of core modules and external covers with side keys for operating a device, such as for push to talk, media or camera controls, and antennas, to accommodate enterprise demands and user needs

There is a need to provide enhanced modular assembly practices, that address manufacturing and cosmetic needs.

There is also a need to provide embedded antennas of various frequencies to support worldwide distribution of products based on a common core module. For example, there is a need to locate antennas in the end caps and/or the side panels.

Thus, a method and device with a customizable core, key pad and end cap assembly that addresses these needs, would be considered an improvement in the art.

### BRIEF DESCRIPTION OF THE DRAWINGS

In order to describe the manner in which the above-recited and other advantages and features of the disclosure can be obtained, a more particular description of the disclosure briefly described above will be rendered by reference to specific embodiments thereof which are illustrated in the appended drawings. Understanding that these drawings depict only typical embodiments of the disclosure and are not therefore to be considered to be limiting of its scope, the disclosure will be described and explained with additional specificity and detail through the use of the accompanying drawings in which:

FIG. 1 is an exemplary block diagram of a communication system according to one embodiment.

FIG. 2 is an exemplary block diagram of a wireless communication device according to one embodiment.

FIG. 3 is an exemplary block diagram of a wireless communication method according to one embodiment.

FIG. 4 is an exemplary perspective view of a wireless communication device according to one embodiment.

FIG. 5 is an exemplary frontal view of a wireless communication device in FIG. 4, showing how a left side module would be connected to a housing according to one embodiment.

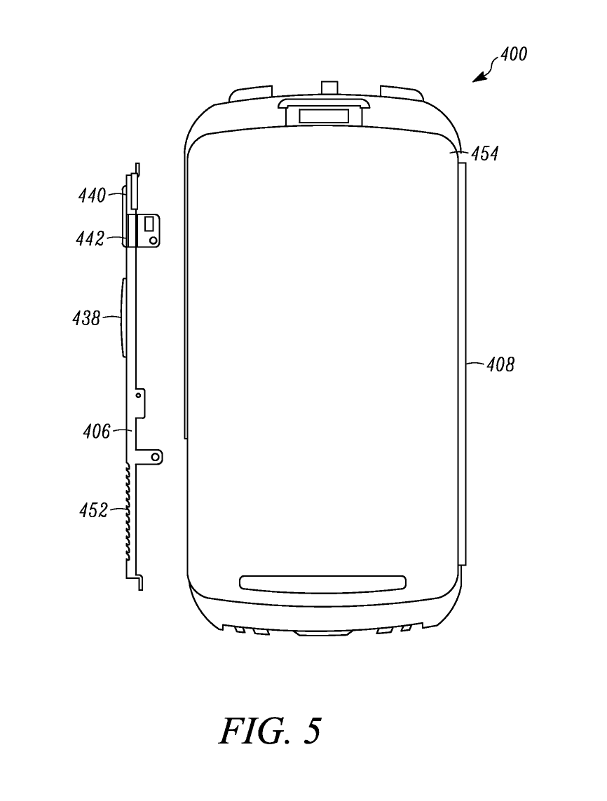

FIG. 6 is an partial cross sectional view of the left side module communication in FIG. 5 according to one embodiment.

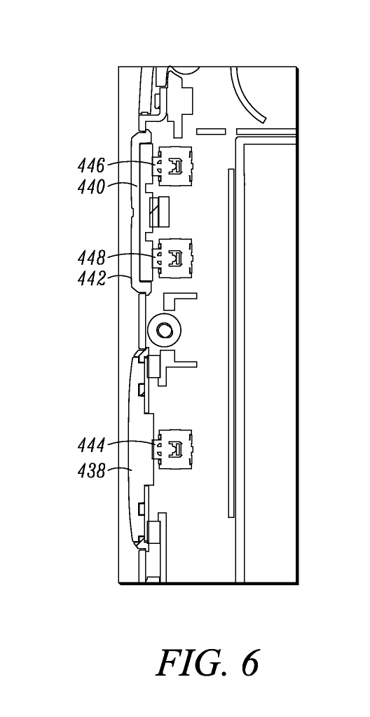

FIG. 7 is an exemplary partial perspective view of a wireless communication device in FIG. 4, showing a left side pad module and bottom end cap module with antennas according to one embodiment.

### DETAILED DESCRIPTION

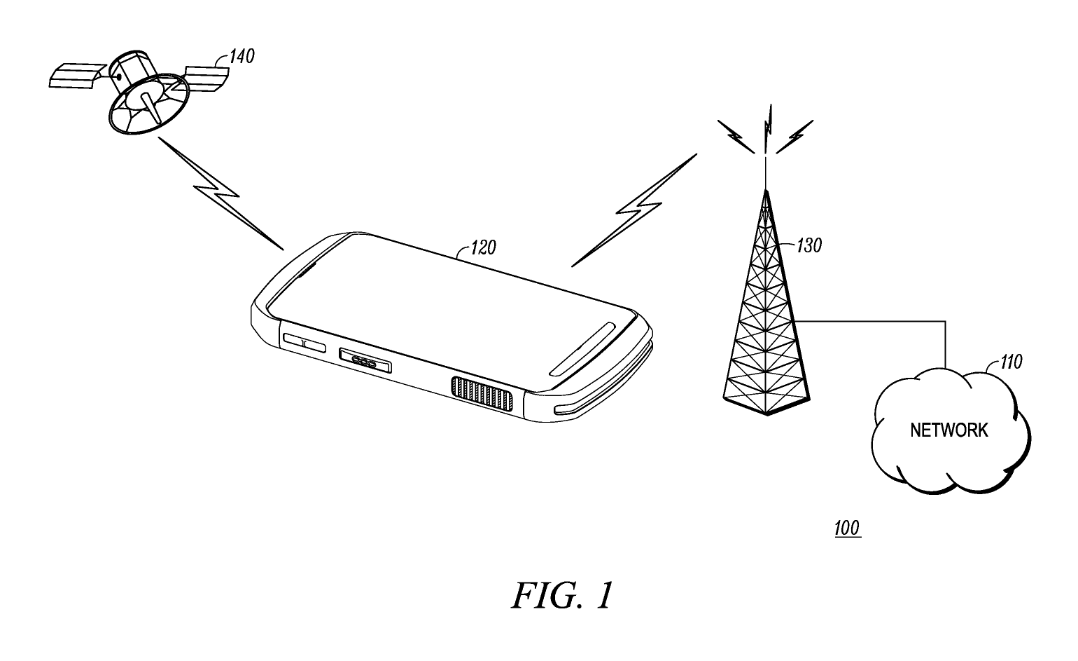

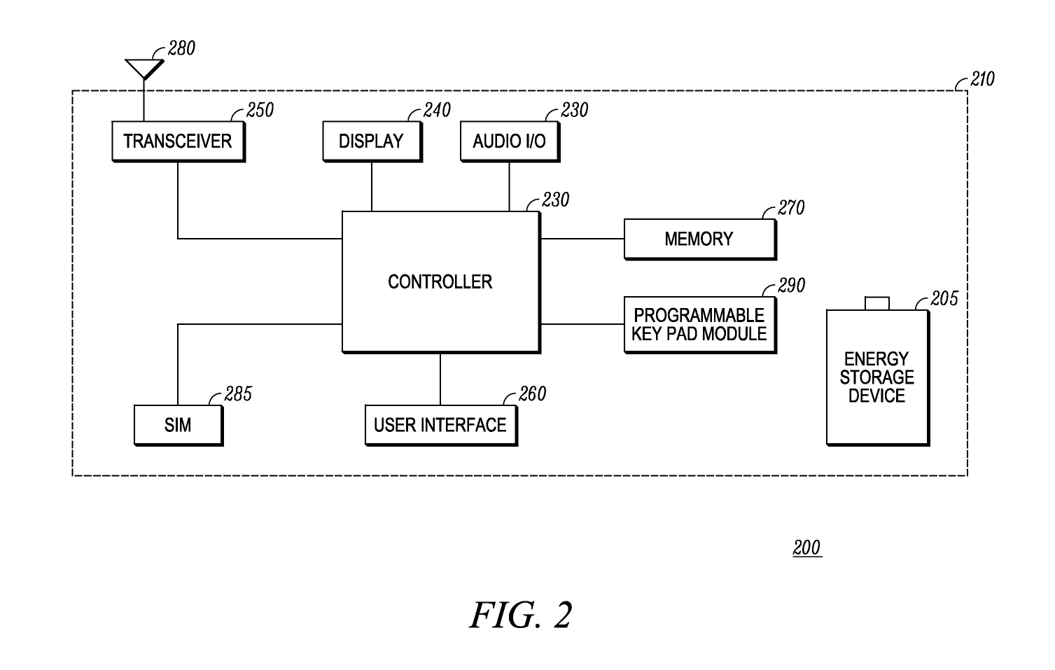

FIG. 1 is an exemplary block diagram of a system 100 according to one embodiment. The system 100 can include a network 110, a terminal 120, and a base station 130. The terminal 120 may be a wireless communication device, such as a wireless telephone, a wearable device, a cellular telephone, a personal digital assistant, a pager, a personal computer, a tablet, a selective call receiver, or any other device that is capable of sending and receiving communication signals on a network including a wireless network. The network 110 may include any type of network that is capable of sending and receiving signals, such as wireless signals. For example, the network 110 may include a wireless telecommunications network, a cellular telephone network, a Time Division Multiple Access (TDMA) network, a Code Division Multiple Access (CDMA) network, Global System for Mobile Communications (GSM), a Third Generation (3G) network, a Fourth Generation (4G) network, a satellite communications network, and other like communications systems. More generally, network 110 may include a Wide Area Network (WAN), a Local Area Network (LAN) and/or a Personal Area Network (PAN). Furthermore, the network 110 may include more than one network and may include a plurality of different types of networks. Thus, the network 110 may include a plurality of data networks, a plurality of telecommunications networks, a combination of data and telecommunications networks and other like communication systems capable of sending and receiving communication signals. In operation, the terminal 120 can include a wireless communication device which can communicate with the network 110 and with other devices on the network 110 by sending and receiving wireless signals via the base station 130, which may also comprise local area, and/or personal area access points, as detailed more fully herein. The terminal 120 is shown being in communication with a global positioning system (GPS) 140 satellite, global navigation satellite system (GNSS) or the like, for position sensing and determination. FIG. 2 is an exemplary block diagram of a wireless communication device 200 configured with an energy storage device, battery or module 205, such as in the terminal 120, for example. The wireless communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, an antenna 280 coupled to the housing 210 and the transceiver 250, and a removable subscriber module 285 coupled to the controller 220.

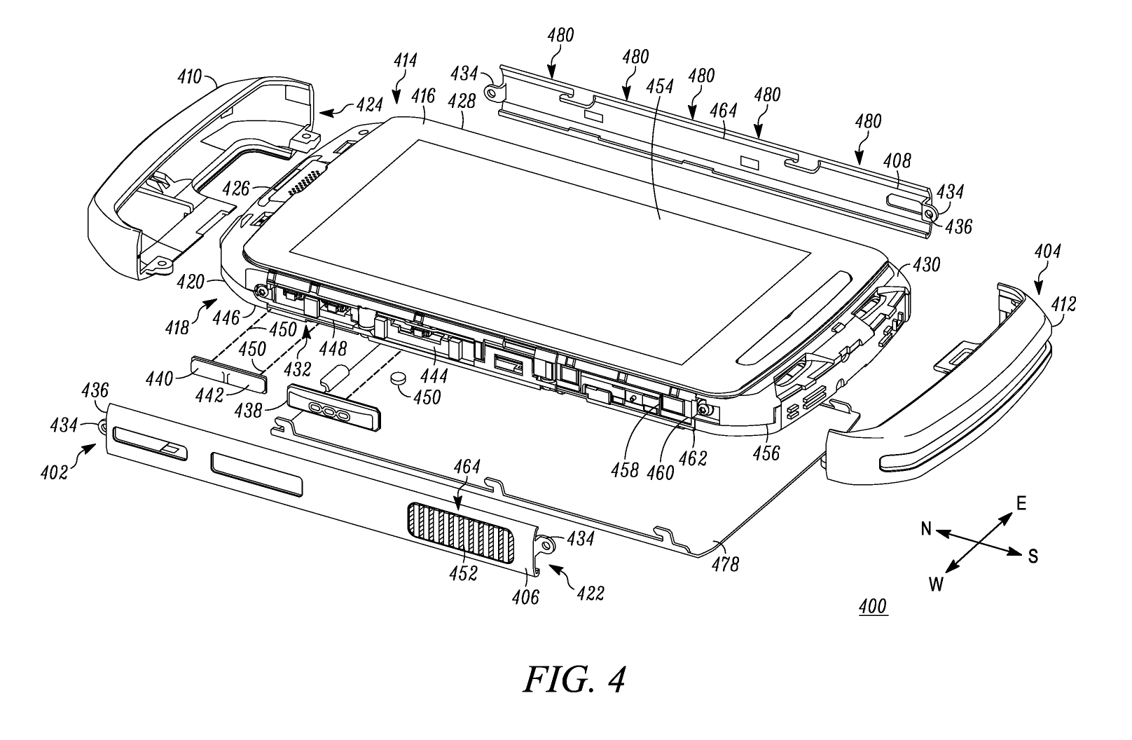

As shown in FIGS. 2 and 4, the wireless communication device 200 further includes a programmable key pad module 290, configured to program a key or plurality of optional keys 480 for a desired operation.

In more detail, the programmable key pad module 290, can allow a user to customize his or her device 400 in any conventional way, such as by downloading, upgrading from a site, loading from a memory stick via a USB connection and the like, if additional keys want to be used.

Thus, a program can be loadable and customizable by a user, by downloading a software program, adjusting a setting and inputting information in a profile, for example. Advantageously, a user can load an application through a USB connection, for example, or download a program to load on a wireless communication device, in the event additional keys want to be used and an appropriate side pad module with keys is used. Similarly, upgrades and customizations can be loaded in any customary way.

In one embodiment, the module 290 can reside within in the controller 220, can reside within the memory 270, can be an autonomous module, can be software, can be hardware, or can be in any other format useful for a module on a wireless communication device 200.

The display 240 can be a liquid crystal display (LCD), a light emitting diode (LED) display, a plasma display, a touch screen display or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch screen or pad, a joystick, an additional display, or any other device useful for providing an interface between a user and an electronic device. The memory 270 may include a random access memory, a read only memory, an optical memory or any other memory that can be coupled to a wireless communication device.

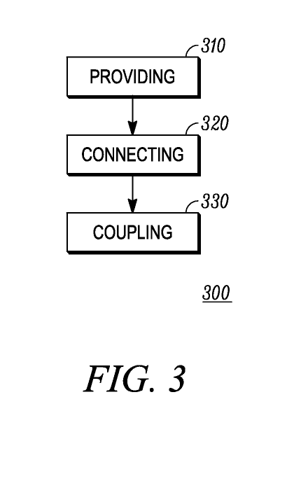

A block diagram of a wireless communication method with customizable key pad assembly, is shown in FIG. 3. In its simplest form, the method 300 can provide the steps of: providing 310 a wireless communication device 400; connecting 320 a side pad module 402 to the wireless communication device 400; and coupling 330 an end cap module 404 to the wireless communication device 400. Advantageously, the method 300 provides an automated, modular and simplified method to assemble a wireless communication device.

With the trend for large displays for wireless communication devices, such as smartphones and tablets, with most if not all of the control being done via touch screen display, it is advantageous to provide universal and customizable end caps and side plates for additional user interfaces.

Advantageously, this structure allows multiple appearances to be created from a single core module or housing by the addition of universal end cap modules, side pad modules and rear covers. This base core module or housing may be manufactured and tested in advance of the customer demand and may then be assembled with custom external covers to suit a customer's desire.

In one embodiment, a plurality of side pad modules including a left side pad module 406 and right side pad module 408, and end cap modules including a top end cap module 410 and bottom end cap module 412 can be assembled with the device, in an efficient and reliable manner, as shown in FIG. 4.

In one arrangement, the providing step 310 includes providing at least one of a narrow profile housing 414, a front display 416 and an energy storage device 205. This can provide a desirable profile and portable device.

In one embodiment, the wireless communication device 400 includes providing a housing and configuring an edge 418 around a periphery 420 of the housing 414 to be complementarily configured to be received by at least a portion (or receptacle portion 422 and 424) of the side pad module 402 and the end cap module 404. This construction can provide a secure connection between the edge of the housing and the side pads and end caps. As should be understood, various shapes and constructions can be provided to interconnect and mate the edge of the housing with the side pad module and the end cap module.

In more detail, the wireless communication device 400 can include providing a housing configured with an edge 418 including a north edge 426, an east edge 428, a south edge 430 and a west edge 432, and the left and right side pad modules 406 and 408 are configured to mate with the east and west edges 428 or 432 and the top and bottom end cap modules 410 and 412 are configured to mate with the north edge 426 and south edge 430, respectively. This construction can provide a robust design that is adapted for ease of assembly and customization.

The method 300 can further comprise overlapping at least a portion of the side pad module 402 with a portion of the end cap module 404, defining an overlap area 434. This feature helps to provide a robust and interconnected portable structure.

In more detail, the overlap area 434 can be near an end portion 436 located below one or both of the end cap module 410 and 412. This overlapped structure can be used for fastening or connecting to the edge 418 of the housing 414.

In one arrangement, the connecting step 320 can include connecting the side pad module 402 to the wireless communication device 400 with a connector and the coupling step 330 includes coupling the end cap module 404 to the wireless communication device with a coupling means. As should be understood, the connecting and coupling steps can be implemented in a number of ways, such as by use of a screw, fastener, snap connector, interconnector and the like.

In one arrangement, the connecting step 320 can include providing the side pad module 402 with a key. This feature can provide easily accessible side key pad.

In one embodiment, a plurality of keys are provided, including a push to talk key 438 and a volume up key 440 and a volume down key 442. Advantageously, a plurality of keys provides simplified operations and functions for a user. For example, the user can activate the push to talk key 438 and/or raise or lower the speaker volume via keys 440 and 442 from the side pad module 406, for example. As should be understood, other keys can be provided for power, media control, camera control, and the like.

The method 300 can further include locating a housing key on an edge of the wireless communication device substantially in registration with a side pad module key. Advantageously, this configuration, alignment and registration can help provide a universal or customizable, enhanced side key pad module.

In one embodiment, a plurality of housing keys 444, 446 and 448 are located in substantial registration (see registration alignment line 450) with a plurality of side pad module keys 438, 440 and 442, respectively. This feature can provide simplified operation from aside or edge, by a user, and can provide a side or edge mounted key pad with a plurality of intuitively located and shaped keys, which can include, for example, a push to talk key 438, volume keys 440 and 442, media control keys and the like. As should be understood, a number of keys can be provided on the east edge 426 and in right side pad module 408, if desired.

In FIG. 4, no keys are provided in in right side pad module 408. They could be, if desired for media and camera control, if desired. The programmable key pad module 290 could be set for these, if desired, and receptacles and keys could be provided on the right side pad module 408, if desired.

In one arrangement, the connecting step 320 can include providing the left side pad module 406 with a grip structure 452. The grip structure 452 can provide enhanced tactility, for a user, when handling, gripping and holding a wireless communication device.

In another arrangement, the coupling step 330 includes coupling the end cap module to the wireless communication device with a coupling device substantially free from being visible from an exterior, as shown in FIG. 1, for an enhanced look.

In another arrangement, the top and bottom end cap modules 410 and 412 and the side cap modules 406 and 408 can include an antenna, speaker port, microphone port, USB connection port, accessory port and a key.

An embodiment of a wireless communication device 400 with customizable key pad assembly, is shown in FIG. 4. The wireless communication device 400 can include: a housing 414 including a front portion 454 and a rear portion 456 and an edge 418 around a periphery 420 of the housing 414; a controller 230 coupled to the housing 414, the controller 230 configured to control the operations of a wireless communication device; and a side pad module 402 and an end cap module 404 connected to the edge 418 of the housing. Advantageously, the device 400 is modular and adapted to being assembled in an automated manner, and provides an enhanced, side mounted user interface or key pad module. In one embodiment, the side pad modules 406 and 408 and an end cap modules 410 and 412 touch and mate three surfaces of the edge 418 of the housing 414, at first, second and third surfaces 458, 460 and 462, respectively, for enhanced and secure framing and interconnecting.

In one arrangement, the side pad modules 406 and 408 and the end cap modules 410 and 412 are complementarily configured to receive and wrap around a portion of the edge 418 of the housing 414, forming a “C shape 464, connecting first, second and third surfaces 458, 460 and 462. This structure can provide for enhanced and secure interconnecting and portability.

In another arrangement, a portion of the side pad modules 408 and 410 and a portion of the end cap modules 410 and 412 overlap, at over lap area 434. This can help to provide a robust and secure interconnected structure. Also, this overlap area 434 can provide for hidden connectors or fasteners, connecting the side pad modules 406 and 408 and end cap modules 410 and 412 to the edge 418 of the housing 414.

The end cap modules 410 and 412 and the side cap modules s 410 and 412 can include an antenna, a speaker port, a microphone port, a USB connection port, an accessory port and one or more keys, for providing for desired features and functionality. A battery door is shown as 478.

As should be understood, a plurality of keys 480 can be placed on right side pad module 408, for media control, for example. Advantageously, the universal and customizable side key pads, can satisfy a user's desires. The shape, basic location and decoration of the actuators for the control keys may be customized.

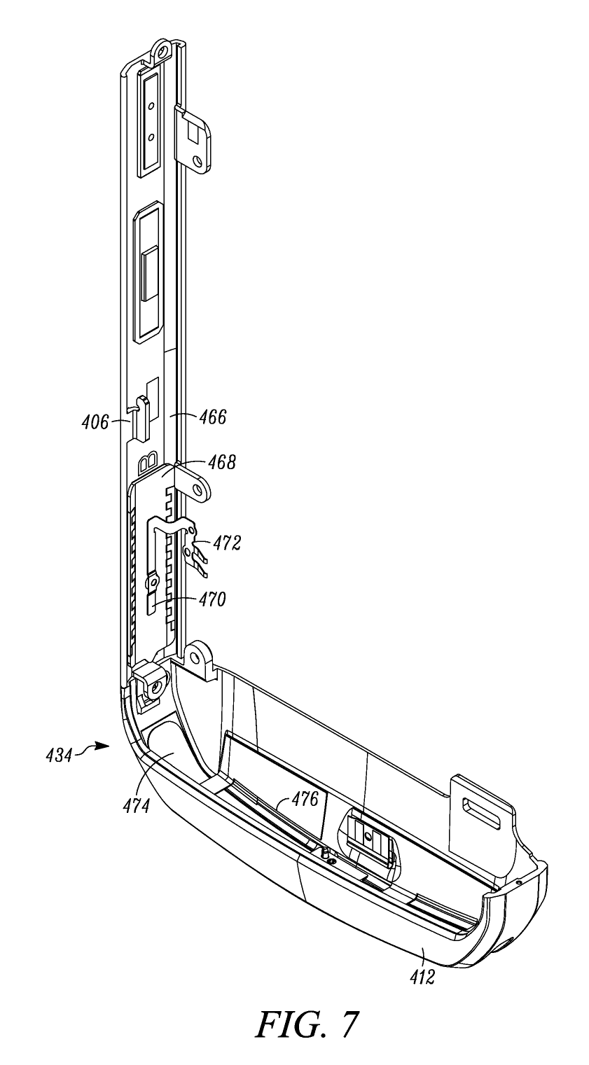

Referring to FIG. 7, the left side pad module 406 and bottom end cap module 412 are shown with antennas. In more detail, an interior 466 of the left side pad module 406 includes an insulator 468 and an antenna, such as a Wi Fi antenna, and a connector 472 for connection to a printed circuit board. Likewise, the bottom end cap module 412 includes an interior 474 and antenna 476 attached thereto. This could be the main antenna or any other antenna. Thus, the interior of the left and right side modules 406 and 408 and top and bottom end cap modules 410 and 412 can include an antenna farm, providing for a plurality of needs, such as main antenna, Wi Fi, Bluetooth, etc. This feature and structure provides for enhanced manufacturability and modular assembly, as the antenna can be customized or specified on a side plate or end cap module, rather than part of the core module or housing 414. This feature can add design options and flexibility, for a manufacturer.

This structure can provide antennas of different frequencies to support worldwide distribution of product, based on a common core module or housing. Advantageously, one method to broaden the opportunities of the core is to move the antennas from the core module to the end caps and/or the side panels. There are multiple processes for the embedding of antenna elements into housing structures commonly used in wireless communication equipments. These antennas may be connected to the main PCB by a variety of separable connection means. The product's matching network may require adjustment for the various antennas by component substitution or by other methods.

The devices 120, 200 and 400 and method 300 are preferably implemented on a programmed processor. However, the controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device on which resides a finite state machine capable of implementing the flowcharts shown in the figures may be used to implement the processor functions of this disclosure. While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure. In this document, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including,” “having,” and the like, as used herein, are defined as “comprising.”

We claim:

1. A wireless communication method, comprising:
providing a wireless communication device;
connecting a side pad module to the wireless communication device; and
coupling an end cap module to the wireless communication device.

2. The wireless communication method of claim 1, wherein the wireless communication device includes providing at least one of a narrow profile housing, a front display and an energy storage device.

3. The wireless communication method of claim 1, wherein the wireless communication device includes providing a housing and configuring an edge of the housing to be complementarily configured to be received by at least a portion of the side pad module and the end cap module.

4. The wireless communication method of claim 1, wherein the wireless communication device includes providing a housing configured with an edge including a north edge, an east edge, a south edge and a west edge.

5. The wireless communication method of claim 1, wherein the wireless communication device includes providing a housing configured with an edge including a north edge, an east edge, a south edge and a west edge and the side pad module is configured to mate with the east or west edge and the end cap is configured to mate with the north or south edges.

6. The wireless communication method of claim 1, further comprising overlapping at least a portion of the side pad module with a portion of the end cap module.

7. The wireless communication method of claim 1, further comprising overlapping at least a portion of the side pad module with a portion of the end cap module, the at least a portion of the side pad module includes an end portion overlapped by the portion of the end cap module including an end portion.

8. The wireless communication method of claim 1, wherein the connecting step includes connecting the side pad module to the wireless communication device with a connector and coupling step includes coupling the end cap module to the wireless communication device with a coupling device.

9. The wireless communication method of claim 1, wherein the connecting step includes providing the side pad module with a key.

10. The wireless communication method of claim 1, wherein the connecting step includes providing the side pad module with a plurality of keys including a push to talk key and a volume key.

11. The wireless communication method of claim 1, further comprising locating a housing key on an edge of the wireless communication device substantially in

12. The wireless communication method of claim 1, further comprising locating a plurality of housing keys in substantial registration with a plurality of side pad module keys.

13. The wireless communication method of claim 1, wherein the connecting step includes providing the side pad module with a grip structure.

14. The wireless communication method of claim 1, wherein the coupling step includes coupling the end cap module to the wireless communication device with a coupling device substantially free from being visible from an exterior.

15. The wireless communication method of claim 1, wherein at least one of the end cap module and the side cap module includes at least one of an antenna, speaker port, microphone port, USB connection port, accessory port and a key.

16. A wireless communication device, comprising:
a housing including a front portion and a rear portion and an edge around a periphery of the housing;
a controller coupled to the housing, the controller configured to control the operations of a wireless communication device; and
a side pad module and an end cap module connected to the edge of the housing.

17. The wireless communication device of claim 16, wherein at least one of the side pad module and the end cap module is complementarily configured to receive and wrap around a portion of the edge of the housing.

18. The wireless communication device of claim 16, wherein a portion of the side pad module and a portion of the end cap module overlap.

19. The wireless communication device of claim 16, wherein at least one of the end cap module and the side cap module includes at least one of an antenna, a speaker port, a microphone port, a USB connection port, an accessory port and a key.
